(19) United States
(12) Patent Application Publication
(10) Pub. No.: US 2026/0156253 A1
(43) Pub. Date: Jun. 4, 2026

(54) FUSION OF INTRA PREDICTION MODES IN VIDEO CODING

(71) Applicant: Alibaba (China) Co., Ltd., Hangzhou (CN)

(72) Inventors: Xinwei LI, Beijing (CN); Ru-ling LIAO, Sunnyvale, CA (US); Jie CHEN, Beijing (CN); Yan YE, San Diego (CA)

(21) Appl. No.: 19/378,153

(22) Filed: Nov. 3, 2025

Related U.S. Application Data
(60) Provisional application No. 63/727,252, filed on Dec. 3, 2024.

(51) Int. Cl. H04N 19/11; H04N 19/46

(52) U.S. Cl. CPC H04N 19/11; H04N 19/46

(57) ABSTRACT

A video decoding method includes: selecting a first intra prediction mode and a second intra prediction mode from a most probable mode (MPM) list; determining a first predictor based on the first intra prediction mode; determining a second predictor based on the second intra prediction mode; blending the first predictor and the second predictor to obtain a blended predictor for intra prediction; and decoding one or more pictures using the blended predictor.

### CROSS-REFERENCE TO RELATED APPLICATIONS

This application claims priority to U.S. Provisional Application No. 63/727,252, titled “FUSION OF INTRA PREDICTION MODES IN VIDEO CODING,” filed on Dec. 3, 2024, which is hereby incorporated by reference in its entirety.

### TECHNICAL FIELD

The present disclosure generally relates to video processing, and more particularly, to methods and apparatuses for performing fusion of intra prediction modes in most probable mode (MPM) list.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards gets higher and higher.

### SUMMARY

In some embodiments, a video decoding method is provided. The video decoding method includes: selecting a first intra prediction mode and a second intra prediction mode from a most probable mode (MPM) list; determining a first predictor based on the first intra prediction mode; determining a second predictor based on the second intra prediction mode; blending the first predictor and the second predictor to obtain a blended predictor for intra prediction; and decoding one or more pictures using the blended predictor.

In some embodiments, a video encoding method is provided. The video encoding method includes: constructing a most probable mode (MPM) list including a first intra prediction mode and a second intra prediction mode; determining a first predictor based on the first intra prediction mode; determining a second predictor based on the second intra prediction mode; blending the first predictor and the second predictor to obtain a blended predictor for intra prediction; and encoding one or more pictures using the blended predictor.

In some embodiments, a method for storing a bitstream is provided. The method for storing a bitstream includes: receiving a video sequence including one or more pictures; generating a bitstream including coded information associated with the video sequence, and storing the bitstream in a non-transitory computer-readable medium. The generating of the bitstream includes: constructing a most probable mode (MPM) list including a first intra prediction mode and a second intra prediction mode; determining a first predictor based on the first intra prediction mode; determining a second predictor based on the second intra prediction mode; and blending the first predictor and the second predictor to obtain a blended predictor for intra prediction.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an example video sequence, according to some embodiments of the present disclosure.

FIG. 2 illustrates a schematic diagram of an example encoder of a video coding system, according to some embodiments of the present disclosure.

FIG. 3 illustrates a block diagram of an example decoder of a video coding system, according to some embodiments of the present disclosure.

FIG. 4 is a block diagram of an example apparatus for encoding or decoding a video, according to some embodiments of the present disclosure.

FIG. 5 is a schematic diagram illustrating example reference samples used in planar mode, according to some embodiments of the present disclosure.

FIG. 6 is a schematic diagram illustrating example angular intra prediction modes, according to some embodiments of the present disclosure.

FIG. 7 is a schematic diagram illustrating adjacent blocks used in the derivation of a general most probable mode (MPM) list, according to some embodiments of the present disclosure.

FIG. 8A is a schematic diagram illustrating samples used by position dependent intra prediction combination (PDPC) applied to a diagonal top-right mode, according to some embodiments of the present disclosure.

FIG. 8B is a schematic diagram illustrating samples used by PDPC applied to a diagonal bottom-left mode, according to some embodiments of the present disclosure.

FIG. 8C is a schematic diagram illustrating samples used by PDPC applied to an adjacent diagonal top-right mode, according to some embodiments of the present disclosure.

FIG. 8D is a schematic diagram illustrating samples used by PDPC applied to an adjacent diagonal bottom-left mode, according to some embodiments of the present disclosure.

FIG. 9 is a schematic diagram illustrating an example L-shaped neighborhood for a given predicted block, according to some embodiments of the present disclosure.

FIG. 10 is a schematic diagram illustrating an example explicit design of a second intra prediction mode in dual MPM, according to some embodiments of the present disclosure.

FIG. 11 is a schematic diagram illustrating an example implicit design of a second intra prediction mode in dual MPM, according to some embodiments of the present disclosure.

FIG. 12 is a flowchart of an example video decoding method, according to some embodiments of the present disclosure.

FIG. 13 is a flowchart for an example method for encoding a video bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc. In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

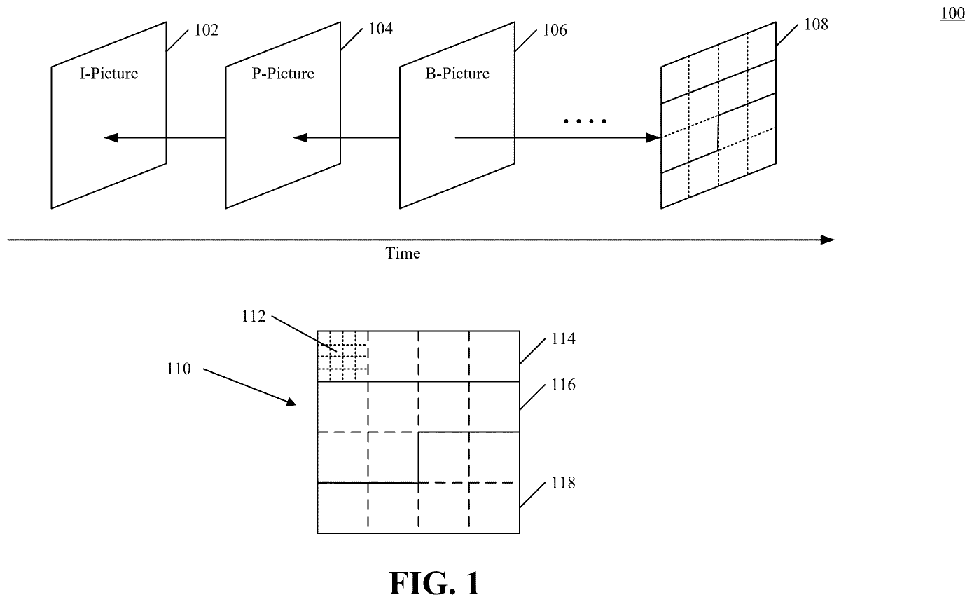

FIG. 1 illustrates structures of an exemplary video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may be not immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples, and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an exemplary structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit, and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vectors (MVs), etc.) required for corresponding coding mode, and quantized residual coefficients are sent.

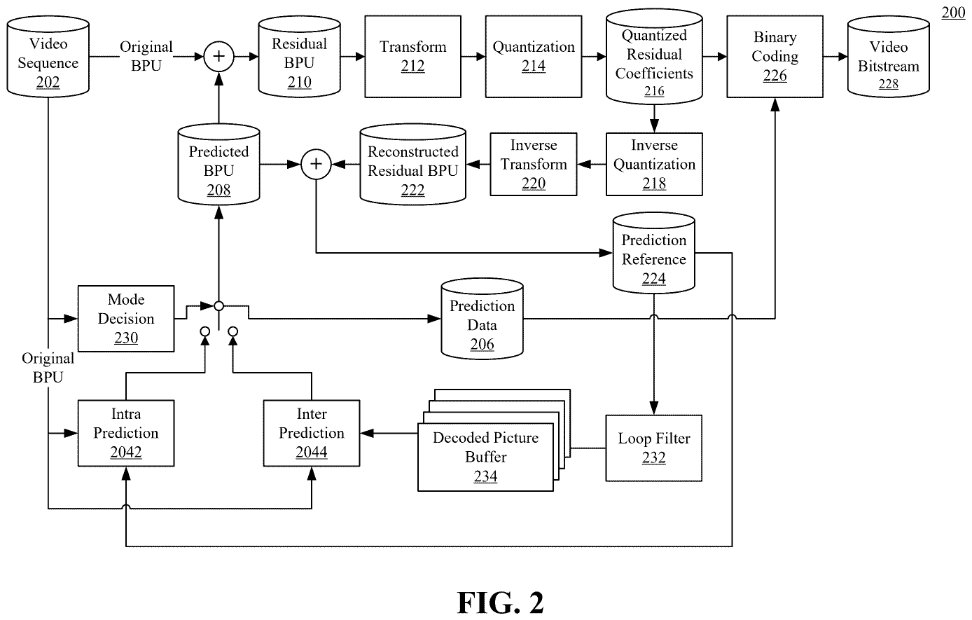

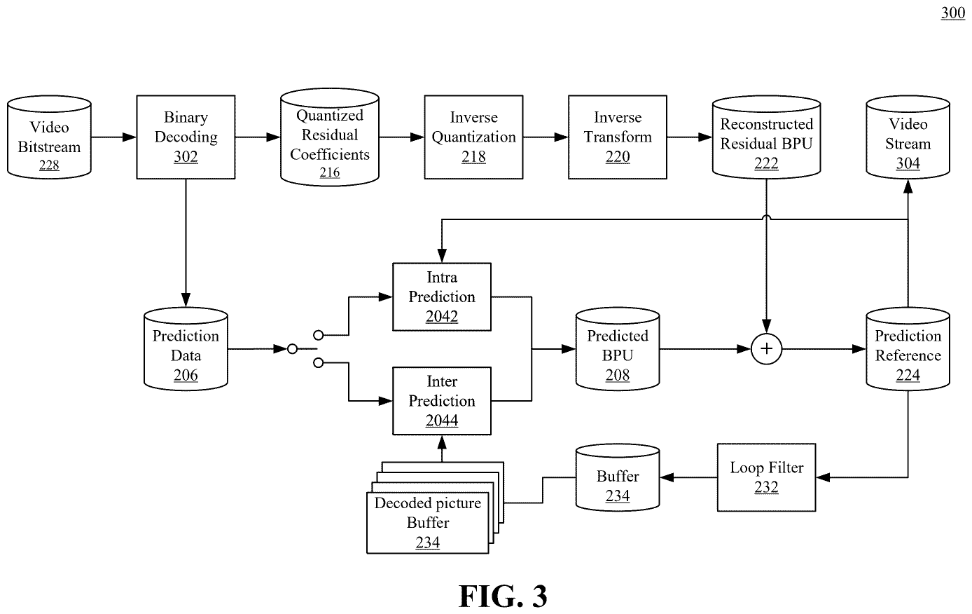

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

FIG. 2 illustrates a schematic diagram of an exemplary encoder 200 of a video coding system, (e.g., AVS3 or H.26x series), according to some embodiments of the present disclosure. The input video is processed block by block. As discussed above, in some coding standards, a coded tree unit (CTU) is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., slices 114-118 in FIG. 1) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensation,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” In other words, MV is the position difference between the reference block in the reference picture and the current block in the current picture. In inter prediction, the reference block is used as the predictor for the current block, so the reference block is also called predicted block. When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In some embodiments, under some specific inter coding modes, such as a skip mode or a direct mode, motion parameters (e.g., MV difference and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a video coding system (e.g., AVS3 or H.26x series), according to some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

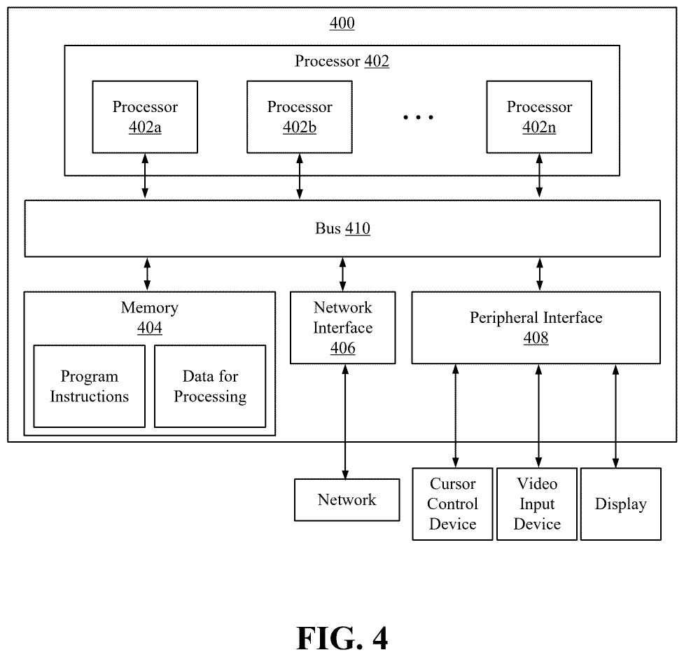

FIG. 4 is a block diagram of an exemplary apparatus 400 for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in FIG. 2 and FIG. 3) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in the present disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

In the inter prediction stage 2044 in FIG. 2 and FIG. 3, reference index is used to indicate which previously coded picture the reference block is from. The motion vector (MV), the position difference between the reference block in the reference picture and the current block in the current picture, is used to indicate the position of the reference block in the reference picture. For bi-prediction (e.g., picture 106 in FIG. 1), two reference blocks, one from a reference picture in reference picture List 0 (e.g., picture 104) and the other from a reference picture in reference picture List 1 (e.g., picture 108) are used to generate the combined predicted block. Accordingly, two reference indices, (e.g., List 0 reference index and List 1 reference index), and two motion vectors (e.g., List 0 motion vector and List 1 motion vector) are required for bi-prediction. The motion vector is determined by the encoder and signaled to the decoder. In some embodiments, to save the signaling cost, a motion vector difference (MVD) is signaled in the bitstream instead. For a decoder, a motion vector predictor (MVP) can be derived based on the spatial and temporal neighboring block motion information, and the MV can be obtained by adding the MVD parsed from the bitstream to the MVP.

As discussed above, the video encoding or decoding process can be achieved using different modes. In some normal inter coding modes, encoder 200 can signal MV(s), corresponding reference picture index for each reference picture list and reference picture list usage flag, or other information explicitly per each CU. On the other hand, when a CU is coded with a skip mode or a direct mode, the motion information, including reference index and motion vector, is not signaled in video bitstream 228 to decoder 300. Instead, the motion information can be derived at decoder 300 using the same rule as encoder 200 does. The skip mode and the direct mode share the same motion information derivation rule and thus have the same motion information. A difference between these two modes is that in the skip mode, the signaling of the prediction residuals is skipped by setting residuals to be zero. In the direct mode, prediction residuals are still signaled in the bitstream.

For example, when a CU is coded with a skip mode, the CU is associated with one PU and has no significant residual coefficients, no coded MV difference or reference picture index. In the skip mode, the signaling of the residual data can be skipped by setting residuals to be zero. In the direct mode, the residual data is transmitted while the motion information and partitions are derived.

On the other hand, in inter modes, encoder 200 can choose any allowed values for motion vector and reference index as the motion vector difference and reference index are signaled to decoder 300. Compared with inter modes signaling the motion information, the bits dedicated on the motion information can thus be saved in the skip mode or the direct mode. However, encoder 200 and decoder 300 need to follow the same rule to derive the motion vector and reference index to perform inter prediction 2044. In some embodiments, the derivation of the motion information can be based on the spatial or temporal neighboring block. Accordingly, the skip mode and the direct mode are suitable for the case where the motion information of the current block is close to that of the spatial or temporal neighboring blocks of the current block.

For example, the skip mode or the direct mode may enable the motion information (e.g., reference index, MVs, etc.) to be inherited from a spatial or temporal (co-located) neighbor. A candidate list of motion candidates can be generated from these neighbors. In some embodiments, to derive the motion information used for inter prediction 2044 in skip mode or direct mode, encoder 200 may first derive the candidate list of motion candidates and select one of the motion candidates to perform inter prediction 2044. When signaling video bitstream 228, encoder 200 may signal an index of the selected candidate. At the decoder side, decoder 300 can obtain the index parsed from video bitstream 228, derive the same candidate list, and use the same motion candidate (including motion vector and reference picture index) to perform inter prediction 2044.

In some embodiments, there are different skip and direct modes, including normal skip and direct mode, ultimate motion vector expression mode, angular weighted prediction mode, enhanced temporal motion vector prediction mode and affine motion compensation skip/direct mode. The candidate list of motion candidates may include multiple candidates obtained based on different approaches. For example, for normal skip and direct model, a motion candidate list may have 12 candidates, including a temporal motion vector predictor (TMVP) candidate (i.e., a temporal candidate), one or more spatial motion vector predictor (SMVPs) candidates (i.e., spatial candidates), one or more motion vector angular predictor (MVAP) candidates (i.e., subblock based spatial candidates), and one or more history-based motion vector predictor (HMVP) candidates (i.e., history-based candidates). In some embodiments, the encoder or the decoder can first derive and add TMVP and SMVP candidates in the candidate list. After adding TMVP and SMVP candidates, the encoder or the decoder derives and add the MVAP candidates and HMVP candidates. In some embodiments, the number of MVAP candidates added in the candidate list may be varied according to the number of available direction(s) in the MVAP process. For example, the number of MVAP candidate(s) may be between 0 to a maximum number (e.g., 5). After adding MVAP candidate(s), one or more HMVP candidates can be added to the candidate list until the total number of the candidates reaches the target number and the largest number can also be signaled in the bitstream.

In some embodiments, the first candidate is the TMVP derived from the MV of collocated block in a pre-defined reference frame. The pre-defined reference frame is defined as the reference frame with reference index being 0 in the List1 for B frame or List0 for P frame. When the MV of the collocated block is unavailable, a MV predictor (MVP) derived based on the MV of spatial neighboring blocks is used as a block level TMVP.

Next, the intra prediction stage 2042 used in the encoder 200 in FIG. 2 and the decoder 300 in FIG. 3 for video coding is described.

According to the VVC standard, the luma component can be predicted by multiple intra prediction modes. For example, the intra prediction modes include, but are not limited to, planar mode, DC mode, angular mode, Multiple Reference Line (MRL) prediction mode, Intra Sub-partition (ISP) mode, Matrix-based Intra Prediction (MIP) mode and Intra Block Copy (IBC) mode.

In Enhanced Compression Model (ECM), several video compression technologies beyond VVC are explored, and some intra prediction modes are extended. In addition, some new intra prediction modes are added, such as Decoder-side Intra Mode Derivation (DIMD) mode, Template-based Intra Mode Derivation (TIMD) mode, intra Template Matching (intra TMP) mode, and Spatial Geometric Partition (SGPM) mode. Details of the above intra prediction modes will be described below.

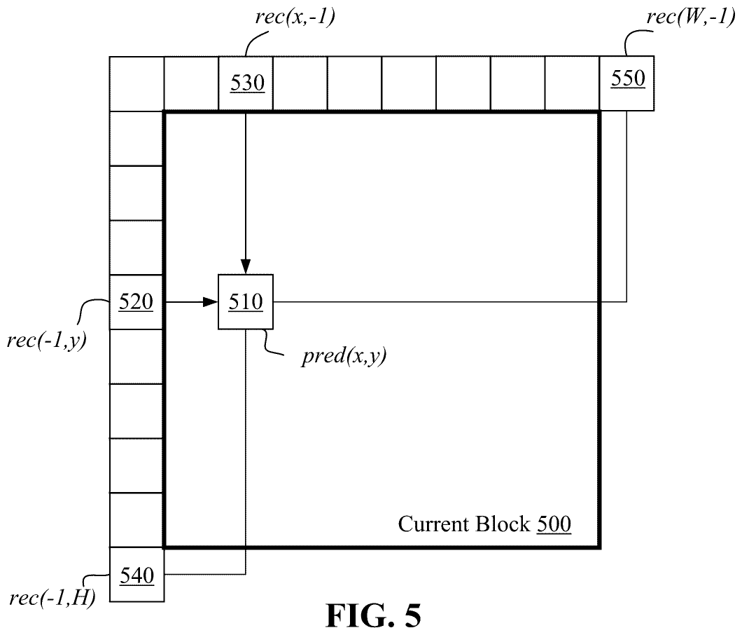

First, planar mode is described. FIG. 5 is a schematic diagram illustrating exemplary reference samples for a current block 500 used in planar mode, according to some embodiments of the present disclosure. In the planar mode, the predicted value of the current sample 510 is obtained from the reconstructed values of 4 reference samples, including the left reference sample 520 in the same row as the current sample, the above reference sample 530 in the same column as the current sample, the reference sample 540 on the bottom-left position adjacent to the current block 500 and the reference sample 550 on the top-right position adjacent to the current block 500. For example, in the embodiments of FIG. 5, pred(x,y) represents the predicted value of the current sample 510, H represents the height of the current block 500, and W represents the width of the current block 500. The reconstructed values of the four reference samples 520-540 used in planar mode can be respectively represented as rec(−1, y), rec(x,−1), rec(−1, H) and rec(W,−1), as shown in FIG. 5, where (x,y) represents the coordinate positions of the current sample 510 relative to the top-left position within the current block 500.

The planar mode generates the predicted value of the current sample 510 according to the following equations. In Equation 1, an intermediate value predV(x,y) can be obtained from reference samples 530 and 540, i.e., rec(x,−1) and rec(−1, H). In Equation 2, another intermediate value predH(x,y) is obtained from reference samples 520 and 550, i.e., rec(−1, y) and rec(W,−1). Finally, the two intermediate values predV(x,y) and predH(x,y) are used to generate the predicted value of the current sample 510 according to Equation 3.

$$( Equation 1 )$$

$$predV ( x , y ) = ( ( H - 1 - y ) * rec ( x , - 1 ) + ( y + 1 ) * rec ( - 1 , H ) ) {( << log )}_{2} W$$

$$( Equation 2 )$$

$$predH ( x , y ) = ( ( W - 1 - x ) * rec ( - 1 , y ) + ( x + 1 ) * rec ( W , - 1 ) ) {( << log )}_{2} H$$

$$( Equation 3 )$$

$$pred ( x , y ) = ( predV ( x , y ) + predH ( x , y ) + W * H ) >> ( {log}_{2} W + {log}_{2} H + 1 )$$

In some embodiments, the planar mode can be represented as index 0.

In ECM, two additional planar modes can be provided, in which only the horizontal interpolation or only the vertical interpolation are used to obtain the predicted samples for luma.

As shown in Equation 4, for a planar horizontal mode, only the horizontal linear interpolation is performed based on the left reference sample and the top-right reference sample to predict the current sample 510.

$$pred ( x , y ) = ( ( W - 1 - x ) * rec ( - 1 , y ) + ( x + 1 ) * rec ( W , - 1 ) + ( W >> 1 ) ) >> {log}_{2} ( W ) \qquad ( Equation 4 )$$

As shown in Equation 5, for a planar vertical mode, only the vertical linear interpolation is performed based on the above reference sample and the bottom-left reference sample to predict the current sample.

$$pred ( x , y ) = ( ( H - 1 - y ) * rec ( x , - 1 ) + ( y + 1 ) * rec ( - 1 , H ) + ( H >> 1 ) ) >> {log}_{2} ( H ) \qquad ( Equation 5 )$$

Next, the DC mode is described. In the DC mode, an average value of the left reference sample 520 and the above reference sample 530 to the current block 500 is used for prediction generation. In HEVC, every intra-coded block has a square shape and the length of each of its side (i.e. left and above) is a power of 2. Thus, no division operations are required to calculate the average value. In VVC, blocks can have a rectangular shape that necessitates the use of a division operation per block in the general case. To avoid division operations for DC prediction, only the longer side is used to compute the average value for non-square blocks. And for square blocks reference samples from both left and above sides are used to compute the average value. In some embodiments, the DC mode can be represented as index 1.

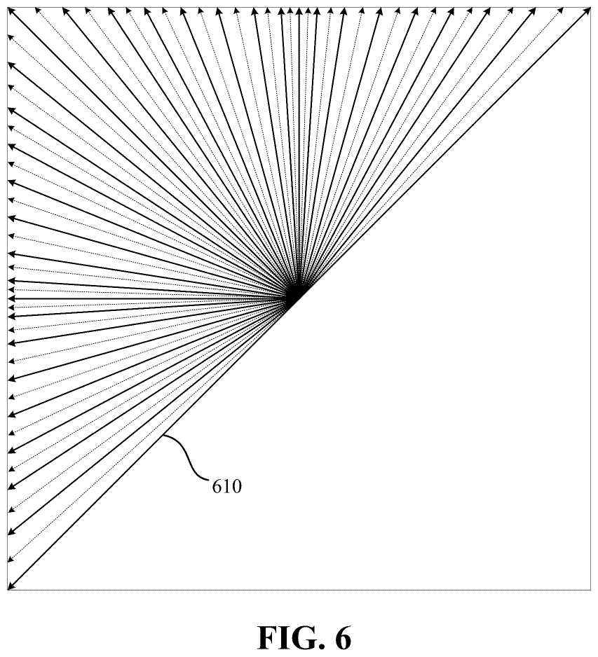

Next, the angular mode is described. FIG. 6 is a schematic diagram illustrating exemplary angular intra prediction modes, according to some embodiments of the present disclosure. Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 6 illustrates angular intra prediction modes 610 according to the VVC standard. The modes added in VVC are illustrated in dotted lines. The 65 angular intra prediction modes 610 can be represented as index 2 to index 66 from bottom left to top right.

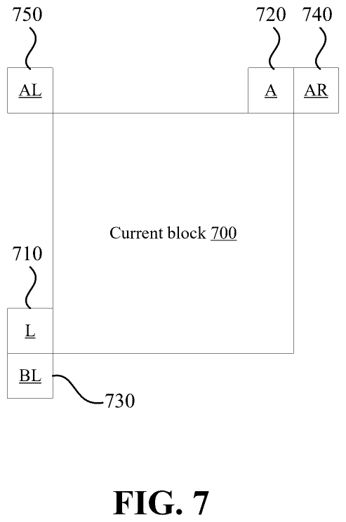

Next, the most probable mode (MPM) list is described. According to the VVC standard, to keep the complexity of the most probable mode (MPM) list generation low, an intra mode coding method with 6 MPMs can be used by considering two available neighboring intra modes. FIG. 7 is a schematic diagram illustrating adjacent blocks 710-750 (e.g., L, A, BL, AR, AL) used in the derivation of a general most probable mode (MPM) list, according to some embodiments of the present disclosure.

In some embodiments, a unified 6-MPM list is used for intra blocks. The MPM list is constructed based on intra modes of the left and above adjacent block. For the mode of the left adjacent block (denoted as Left) and the mode of the above adjacent block (denoted as Above), the unified MPM list is constructed based on the following rules. First, when an adjacent block is not available, its intra mode is set to the planar mode by default. Second, if both modes of the left adjacent block and the above adjacent block (i.e., Left and Above) are non-angular modes, the MPM list is constructed as {Planar, DC, V, H, V−4, V+4}. Third, if one of modes of the left adjacent block and the above adjacent block (i.e., Left and Above) is angular mode, and the other is non-angular, a first mode Max is set as the larger mode in the left adjacent block and the above adjacent block (i.e., Left and Above), and the MPM list is constructed as {Planar, Max, Max−1, Max+1, Max−2, Max+2}.

Fourth, if the modes of the left adjacent block and the above adjacent block (i.e., Left and Above) are both angular and are different, a first mode Max is set as the larger mode in the left adjacent block and the above adjacent block (i.e., Left and Above), and a second mode Min is set as the smaller mode in the left adjacent block and the above adjacent block (i.e., Left and Above). If Max−Min is equal to 1, the MPM list is constructed as {Planar, Left, Above, Min−1, Max+1, Min−2}. Otherwise, if Max−Min is greater than or equal to 62, the MPM list is constructed as {Planar, Left, Above, Min+1, Max−1, Min+2}. Otherwise, if Max-Min is equal to 2, the MPM list is constructed as {Planar, Left, Above, Min+1, Min−1, Max+1}. Otherwise, the MPM list is constructed as {Planar, Left, Above, Min−1,−Min+1, Max−1}. Fifth, if the modes of the left adjacent block and the above adjacent block (i.e., Left and Above) are both angular and they are the same, the MPM list is constructed as {Planar, Left, Left−1, Left+1, Left−2, Left+2}.

For a CU, a MPM flag can be signaled to indicate whether an intra prediction mode in the MPM list is used. If the MPM flag is true, an index is signaled to indicate which intra prediction mode in the MPM list is used.

According to the ECM proposal, secondary MPM lists is introduced. The existing primary MPM (PMPM) list includes 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left adjacent block 710 (L), the above adjacent block 720 (A), the below-left adjacent block 730 (BL), the above-right adjacent block 740 (AR), and the above-left adjacent block 750 (AL) as shown in FIG. 7, and DIMD modes which are sorted in ascending order of SAD cost. Up to 5 modes with the smallest SAD cost are added. The SAD cost is computed between the prediction and the reconstruction samples of the template. The sorted directional modes with added offset are added into the general MPM list, and then the default modes are added into the general MPM list, until the general MPM list with 22 entries is constructed.

In some embodiments, if a block is vertically oriented, the sequence of neighbouring blocks is A, L, BL, AR, AL; otherwise, the sequence of neighbouring blocks is L, A, BL, AR, AL.

For a CU, a MPM flag is signaled to indicate whether an intra prediction mode in the PMPM list is used. If the PMPM flag is true, an index is signaled to indicate which intra prediction mode in the PMPM list is used. If the PMPM flag is false, another SMPM flag is signaled to indicate whether an intra prediction mode in the SMPM list is used. If the SMPM flag is true, another index is signaled to indicate which intra prediction mode in the SMPM list is used.

According to an ECM proposal, the intra modes derived by DIMD method can also be added to the MPM list. According to an ECM proposal, the intra modes of the non-adjacent blocks can also be added to the MPM list.

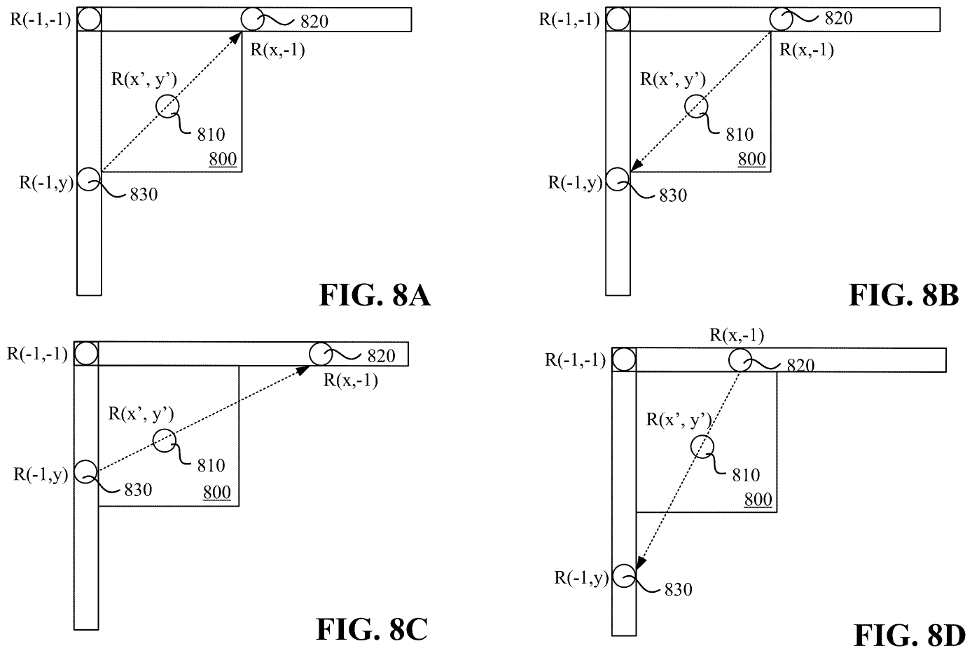

Next, position dependent intra prediction combination (PDPC) is described. FIGS. 8A-8D are schematic diagrams illustrating samples used by position dependent intra prediction combination (PDPC), according to some embodiments of the present disclosure. In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signaling: planar, DC, angular modes with an index less than or equal to the horizontal mode index, and angular modes with an index greater than or equal to the vertical mode index.

In some embodiments, the prediction sample pred(x′,y′) is predicted using an intra prediction mode (e.g., a DC mode, a planar mode, or an angular mode) and a linear combination of reference samples according to Equation 6.

$$pred ( {x}^{′} , {y}^{′} ) = Clip ( 0 , ( 1 << BitDepth ) - 1 , ( wL \times {R}_{- 1 , {y}^{′}} + wT \times {R}_{{x}^{′} , - 1} + ( 64 - wL - wT ) \times pred ( {x}^{′} , {y}^{′} ) + 32 ) >> 6 ) , \qquad ( Equation 6 )$$

where Rₓ₋₁, R_{-1,y} represent the reference samples located at the top and left boundaries of current sample (x,y), respectively.

PDPC process for DC and Planar modes is identical. For angular modes, if the current angular mode is the horizontal mode (HOR_IDX) or the vertical mode (VER_IDX), left or top reference samples is not used, respectively. The PDPC weights and scale factors are dependent on prediction modes and the block sizes. PDPC is applied to the block with both width and height greater than or equal to 4.

FIGS. 8A-8D illustrate the definition of reference samples 820 and 830 (i.e., R_{x,-1} and R_{-1,y}) for PDPC applied over various prediction modes, namely, diagonal top-right mode in FIG. 8A, diagonal bottom-left mode in FIG. 8B, adjacent diagonal top-right mode in FIG. 8C, and adjacent diagonal bottom-left mode in FIG. 8D. The prediction sample 810, i.e., pred(x′,y′), is located at (x′,y′) within the prediction block 800. As an example, the coordinate x of the reference sample 820, i.e., R_{x,-1}, is given by: x=x′+y′+1, and the coordinate y of the reference sample 830, i.e., R_{-1,y}, is similarly given by: y=x′+y′+1 for the diagonal modes. For the other angular mode, the reference samples 820 and 830, i.e., R_{x,-1} and R_{-1,y}, could be located in fractional sample position. In this case, the sample value of the nearest integer sample location is used.

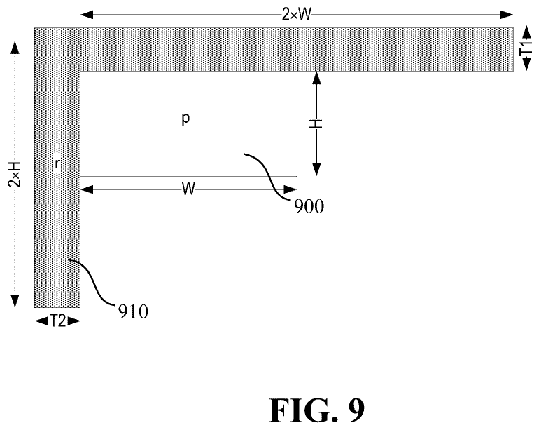

Next, position dependent intra prediction (PDP) replacement is described. According to an ECM proposal, some of the conventional intra prediction modes (planar, DC and the 65 angular modes) may be replaced by matrix based intra prediction modes which called position dependent prediction replacement (PDP replacement). In the matrix based intra prediction mode, a matrix of weights, which are defined for a block shape and intra mode index, is introduced. Those weights are multiplied by the neighbour reference template to derive the predicted values of the current block. FIG. 9 is a schematic diagram illustrating an L shaped neighborhood for a given predicted block 900, according to some embodiments of the present disclosure. The weights are applied to the reference samples 910 of the L shaped causal neighborhood template as shown in FIG. 9.

The reference samples 910 in the causal neighborhood are denoted as r, and F(x,y) is the matrix of weights. Then the predicted value pred(x,y) can be derived according to Equation 7.

$$pred ( x , y ) = {\sum }_{k} F ( x , y , k ) * r ( k ) , \qquad ( Equation 7 )$$

where k denotes the index of the reference sample in the template.

The prediction is used for block size with both width and height up to 32 (except for 4×32, 32×4, 8×32 and 32×8). The template size is 2 for blocks with both width and height up to 16 and the modes with index 0, 1, and (2+2×k) are replaced. For other blocks, template size is set to 1 and the modes with index 0, 1, and (2+4×k) are replaced. The prediction is only performed for 16×16 positions, and the rest of the samples are generated by bilinear interpolation. For all block sizes, block shape and mode-based symmetry is used. Reference length is set to W and H for modes with index greater than 18 and less than 50 and set to 2×W and 2×H for other modes.

Next, intra fusion mode with different reference lines are described. According to an ECM proposal, an intra fusion mode with different reference lines is applied. This intra prediction method derives predicted samples as a weighted combination of multiple predictors generated from different reference lines. In this process multiple intra predictors are generated and then fused by weighted averaging. For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.

The angular intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

Next, decoder side intra mode derivation (DIMD) mode is described. In ECM, a decoder side intra mode derivation (DIMD) mode is applied. Up to five intra prediction modes among angular modes are derived from the reconstructed neighbor samples, and those five predictors are combined with the planar mode predictor with the weights derived from a histogram of gradients.

Next, template-based intra mode derivation (TIMD) mode is described. In ECM, a template-based intra mode derivation (TIMD) mode is applied. For each intra prediction mode in a list, the SATD value between the prediction and reconstruction samples of a L-shaped template is calculated. First two intra prediction modes with the minimum SATD value are selected as the TIMD modes. These two TIMD modes are fused with SATD based weights, and such weighted intra prediction is used to code the current CU.

In the current design of the MPM list, the MPM list contains the most likely modes for predicting the current block. However, in the current design of ECM, only one intra prediction mode from the MPM list is selected to predict the current block, and a single intra prediction mode may not be sufficient to predict blocks with different textures. In the intra fusion mode with different reference lines, two predictors can be blended to generate the final predictors, but the two predictors are generated by one intra prediction mode with different reference lines.

The present disclosure provides solutions to one or more of the above-described problems. In some embodiments consistent with the present disclosure, two predictors generated by two different intra prediction modes from the MPM list can be blended to generate a new predictor of the current block. The two predictors can be blended as the following Equation 8.

$$P ( x , y ) = ( P 0 ( x , y ) * w 0 + P 1 ( x , y ) * w 1 + offset ) >> shift \qquad ( Equation 8 )$$

where (x,y) are the sample position in the current block, P is the final prediction of the current block, P0 and P1 are the two predictors generated by the two intra prediction modes, w0 and w1 are the weights applied to the two predictors, offset and shift are related to the two weights.

In some embodiments of the present disclosure, the proposed method can be defined as a dual MPM mode. These two intra prediction modes can be represented as mode0 and model.

Next, the operations for the determination of intra prediction modes in a dual MPM method will be described.

In some embodiments, the two intra prediction modes come from the PMPM list. In some embodiments, the two intra prediction modes come from the PMPM list and the SMPM list.

In the current ECM design, a MPM index is signaled to indicate which intra prediction mode in the MPM list is selected to predict the current block. In the dual MPM method, the first mode (e.g., mode0) can be the determined by the signaled MPM index, and the second mode (e.g., mode1) can be determined in different ways.

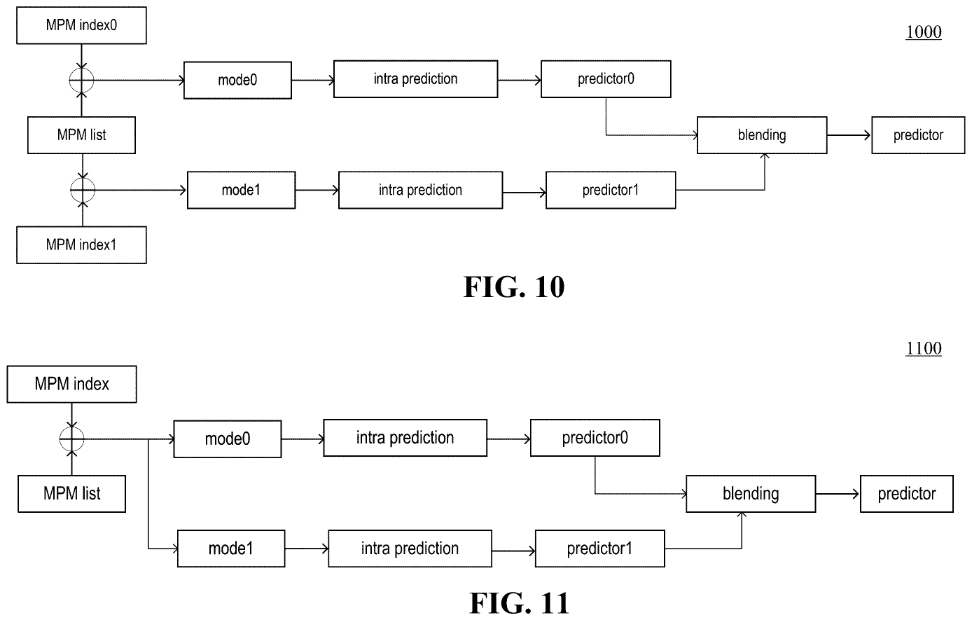

FIG. 10 is a schematic diagram illustrating an exemplary explicit design 1000 of a second intra prediction mode in dual MPM, according to some embodiments of the present disclosure. In some embodiments, an explicit method is used to indicate the second mode (e.g., model). As shown in FIG. 10, a first MPM index, index0, is signaled to indicate which intra prediction mode in the MPM list is used as the first intra prediction mode (e.g., mode0) to predict the current block, and a second MPM index, index 1, is signaled to indicate which intra prediction mode in the MPM list is used as the second intra prediction mode (e.g., model). As shown in FIG. 10, a first predictor (e.g., predictor0) can be determined based on the first intra prediction mode (e.g., mode0), and a second predictor (e.g., predictor1) can be determined based on the second intra prediction mode (e.g., model). Then, the first predictor and the second predictor are blended to obtain a blended predictor for intra prediction.

FIG. 11 is a schematic diagram illustrating an exemplary implicit design 1100 of a second intra prediction mode in dual MPM, according to some embodiments of the present disclosure. In some embodiments, the implicit method shown in FIG. 11 is used to determine the second intra prediction mode. For example, the first intra prediction mode (e.g., mode0) can be selected based on a first MPM index, and the second intra prediction mode (e.g., mode1) can be selected based on a second MPM index determined based on the first MPM index. Then, similar to the embodiments of FIG. 10, a first predictor (e.g., predictor0) can be determined based on the first intra prediction mode (e.g., mode0), and a second predictor (e.g., predictor1) can be determined based on the second intra prediction mode (e.g., model). Then, the first predictor and the second predictor are blended to obtain a blended predictor for intra prediction.

As an example, the second intra prediction mode (e.g., mode1) can be the intra prediction mode before the first intra prediction mode (e.g., mode0) in the MPM list. For example, if the first intra prediction mode is the 3^{rd} intra prediction in the MPM list, then the 2^{nd} intra prediction in the MPM list is used as the second intra prediction mode.

As another example, the second intra prediction mode (e.g., mode1) can be the intra prediction mode after the first intra prediction mode in the MPM list. For example, if the first intra prediction mode is the 3^{rd} intra prediction in the MPM list, then the 4^{th} intra prediction in the MPM list is used as the second intra prediction mode.

In some embodiments, the second intra prediction mode can be the planar mode. In some other embodiments, the second intra prediction mode can be the intra prediction mode derived by DIMD or TIMD method.

In some other embodiments, the second intra prediction mode can be the first non-planar mode in the MPM list. The 1^{st} mode in the MPM list is fixed to the planar mode, so that the first non-planar mode should be the 2^{nd} mode in the MPM list.

In some other embodiments, the second intra prediction mode can be determined by a template-based method. For example, all the intra prediction modes in the MPM list are used to predict a template of the current block. Then the cost between prediction samples and reconstruction samples of the template are calculated. The cost can be the Sum of Absolute Difference (SAD) or the Sum of Absolute Transformed Difference (SATD). The intra prediction mode with the smallest template matching cost is used as model.

In some embodiments, a new mode list is constructed where each entry contains a pair of intra prediction modes from the MPM list. Each pair represents two intra prediction modes which can be used in the dual MPM method. In some embodiments, the entries in the new mode list can be reordered based on their template matching cost. To calculate the template matching cost for an entry, both intra prediction modes of the entry are used to predict a template of the current block and the two predictors are blended. Then the SAD or SATD values are calculated between the blended prediction samples and reconstruction samples of the template.

In some embodiments, an index can be signaled to indicate which pair of intra prediction modes is used to predict the current block in the dual MPM. In some other embodiments, the pair with the smallest template matching cost is used to predict the current block in the dual MPM. It is noted that, the two intra prediction modes should be different in the dual MPM.

In some embodiments, the planar mode is not included in the two intra prediction modes used in the dual MPM.

Next, the operations for the determination of blending will be described.

In various embodiments of the present disclosure, multiple methods are provided for determining whether to enable the dual MPM method and blend two intra predictors generated by two intra prediction modes in the MPM list.

In some embodiments, an explicit method is used to determine whether to use the dual MPM by signaling a flag to indicate whether to use dual MPM. For example, the flag can be signaled after signaling the MPM flag. In another example, the flag can be signaled after signaling the MPM flag and MPM index. In yet another example, the flag can be signaled before signaling the MPM flag.

In some embodiments, an implicit method is used to determine whether to use dual MPM. For example, the template matching cost can be used to determine whether to use dual MPM. After the first and the second intra prediction modes are determined, the two intra prediction modes are used to predict a template of the current block. Then, the two predictors are blended and the two template matching costs are calculated. The first template matching cost is calculated between prediction samples of the predictor generated by the first intra prediction mode and reconstruction samples. The second template matching cost is calculated between prediction samples of the blended predictor and reconstruction samples. The cost function can be SAD or SATD. If the second template matching cost is less than the first template matching cost, the dual MPM method is enabled and used; otherwise, the dual MPM method is disabled.

Next, the blending weights of the dual MPM method will be described. In various embodiments of the present disclosure, multiple methods are provided to determine the two weights w0 and w1 for blending the first predictor and the second predictor.

In some embodiments, two fixed weights can be used. In one example, the first blending weight w0 is equal to the second blending weight w1. For example, w0=4, w1=4, offset=4 and shift=3. In another example, the second blending weight w1 is equal to three times the first blending weight w0. For example, w0=2, w1=6, offset=4 and shift=3.

In some embodiments, an explicit method is used to determine the weights. A list of weights can be provided and an index is signaled to indicate which candidate of weights is used. For example, the list of weights can be: {w0=1, w1=7; w0=2, w1=6; w0=3, w1=5; w0=4, w1=4; w0=5, w1=3; w0=6, w1=2; w0=7, w1=1} and offset=4 and shift=3.

In some embodiments, an implicit method can be used to determine the blending weights. As an example, the template matching cost is used to select the weights from a list. The template matching costs by using each candidate of weights in the list is calculated. That is predicting the template of the current block by the two intra prediction modes and blended their predictors with the weights in the list. The template matching cost is calculated between prediction samples of the blended predictor and reconstruction samples. The cost function can be SAD or SATD. The candidate of weights with the smallest template matching cost is selected.

As another example, the blending weights can be determined by the template matching cost. The two intra prediction modes are used to predict the template of the current block. Then two template matching costs are calculated between the two prediction samples of the two predictors and reconstruction samples of the template, respectively. The cost function can be SAD or SATD. The two weights are calculated by the two template matching costs. For example, the weight of an intra prediction mode is inversely proportional to its template matching cost.

In another example, the blending weights are determined by a regression-based method. In this way, two sample-wise weights W0(x,y) and W1(x,y) are used to blend the two predictors based on the following Equation 9.

$$( Equation 9 )$$

$$P ( x , y ) = ( P 0 ( x , y ) * W 0 ( x , y ) + P 1 ( x , y ) * W 1 ( x , y ) + offset ) >> \text{shift.}$$

The two blending weights W0(x,y) and W1(x,y) can be derived from a template of the current block. The weights are modelled as an affine linear function of the sample positions (x,y) to the top-left sample in the current CU according to Equation 10 and Equation 11, where n is a positive integer value.

$$W 0 ( x , y ) = a * x + b * y + c \qquad ( Equation 10 )$$

$$W 1 ( x , y ) = n - W 0 ( x , y ) \qquad ( Equation 11 )$$

In some embodiments, the blending matrices are modelled according to Equation 12 and Equation 13, where n is a positive integer value.

$$W 1 ( x , y ) = a * x + b * y + c \qquad ( Equation 12 )$$

$$W 0 ( x , y ) = n - W 1 ( x , y ) \qquad ( Equation 13 )$$

The parameters (a, b, c) are derived from the template using a MSE minimization method. Two intra prediction modes are used to predict the template to obtain two predictors, respectively. Then the MSE minimization is performed to minimize the difference between the prediction samples of the blended predictor and the reconstruction samples of the template.

Next, the operations for the prediction of the dual MPM method will be described. In some embodiments, one or more features or operations are disabled when the dual MPM method is used. For example, in some embodiments, the PDP replacement is disabled when the dual MPM method is used. In some embodiments, the PDPC is disabled when the dual MPM method is used. In some embodiments, the intra fusion with different reference lines is disabled, when the dual MPM method is used.

Next, the restrictions for the proposed MPM list are described. In some embodiments, a block size-based restriction can be applied to the dual MPM method. In one example, the dual MPM is disabled if the area of the current block is smaller than a threshold. In another example, the dual MPM is disabled if the area of the current block is larger than a threshold. A high-level flag used to indicate whether the dual MPM is enabled or not may be signaled at SPS-level, PPS-level, picture header or slice header.

Next, a multiple MPM method is described. In some embodiments, up to N predictors generated by N different intra prediction modes from the MPM list are blended to generate a new predictor of the current block. The value of N can be any positive integer larger than 2. The N predictors can be blended as the following Equation 14.

$$P ( x , y ) = ( {P}_{0} ( x , y ) * {w}_{0} + {P}_{1} ( x , y ) * {w}_{1} + \text{} ⋯ + {P}_{N - 1} ( x , y ) * {w}_{N - 1} + offset ) >> shift , \qquad ( Equation 14 )$$

where (x, y) are the sample position in the current block, P is the final prediction of the current block, P₀ to P_{N-1} are the N predictors generated by the N intra prediction modes, w₀ to w₁ are the weights applied to the N predictors, offset and shift are related to the N weights.

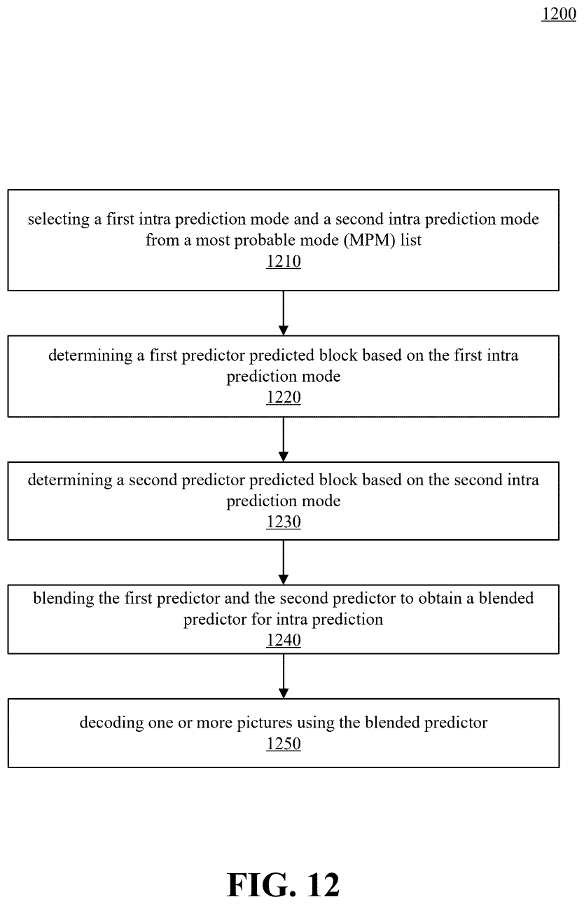

FIG. 12 is a flowchart of an example video decoding method 1200, according to some embodiments of the present disclosure. In some embodiments, the video decoding method 1200 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the video decoding method 3400. As shown in FIG. 12, the video decoding method 1200 may include steps 1210-1250.

At step 1210, the decoder selects a first intra prediction mode and a second intra prediction mode from a most probable mode (MPM) list. As discussed above, in some embodiments, at step 1210, the decoder may select the first intra prediction mode based on a first MPM index signaled in the bitstream and select the second intra prediction mode based on a second MPM index signaled in the bitstream. In some other embodiments, at step 1210, the decoder may select the first intra prediction mode based on a first MPM index signaled in a bitstream, determine a second MPM index based on the first MPM index, and select the second intra prediction mode based on the second MPM index. In some embodiments, the first intra prediction mode and the second intra prediction mode may be adjacent modes in the MPM list.

At step 1220, the decoder determines a first predictor based on the first intra prediction mode. At step 1230, the decoder determines a second predictor based on the second intra prediction mode.

At step 1240, the decoder blends the first predictor and the second predictor to obtain a blended predictor for intra prediction. In some embodiments, the decoder may determine whether to blend the first predictor and the second predictor based on a flag signaled in the bitstream. In some embodiments, at step 1240, the decoder may determine a weighted combination of the first predictor and the second predictor. In various embodiments, the first weight for the first predictor and the second weight for the second predictor can be determined using various methods. For example, the first weight for the first predictor and the second weight for the second predictor can be determined based on the template matching cost. Then, after the blended predictor is obtained, at step 1250, the decoder decodes one or more pictures using the blended predictor.

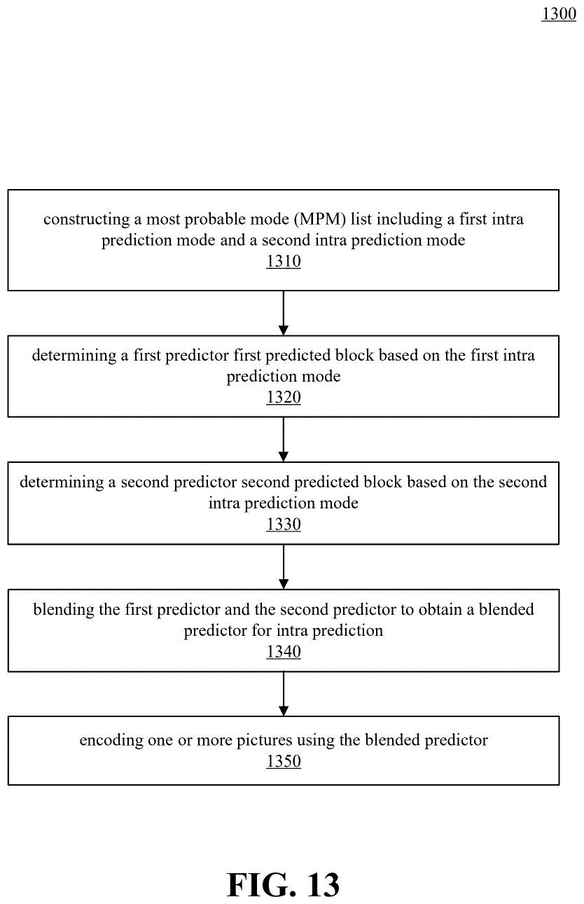

FIG. 13 is a flowchart for an example video encoding method 1300 for encoding a video bitstream, according to some embodiments of the present disclosure. The video encoding method 1300 can be performed by an encoder (e.g., encoder 200 in FIG. 2) to encode a video bitstream. For example, the encoder can be implemented as one or more software or hardware components of an apparatus (e.g., apparatus 400 in FIG. 4) for encoding the bitstream (e.g., video bitstream 228 in FIG. 2) for reconstructing a video frame or a video sequence. For example, a processor (e.g., processor 402 in FIG. 4) can perform the video encoding method 1300. As shown in FIG. 13, the video encoding method 1300 includes the following steps 1310-1350.

At step 1310, the encoder constructs a most probable mode (MPM) list including a first intra prediction mode and a second intra prediction mode. In some embodiments, the encoder may encode a first MPM index for selecting the first intra prediction mode in the bitstream and encode a second MPM index for selecting the second intra prediction mode in the bitstream. In some other embodiments, the encoder may encode the first MPM index for selecting the first intra prediction mode in the bitstream, in which the second MPM index for selecting the second intra prediction mode can be determined based on the first MPM index. For example, the first intra prediction mode and the second intra prediction mode can be adjacent modes in the MPM list.

At step 1320, the encoder determines a first predictor based on the first intra prediction mode. At step 1330, the encoder determines a second predictor based on the second intra prediction mode.

At step 1340, the encoder blends the first predictor and the second predictor to obtain a blended predictor for intra prediction. In some embodiments, the encoder may encode a flag for determining whether to blend the first predictor and the second predictor in the bitstream. In some embodiments, at step 1340, the encoder may determine a weighted combination of the first predictor and the second predictor. In various embodiments, the first weight for the first predictor and the second weight for the second predictor can be determined using various methods. For example, the first weight for the first predictor and the second weight for the second predictor can be determined based on the template matching cost. Then, after the blended predictor is obtained, at step 1350, the encoder encodes one or more pictures using the blended predictor.

The embodiments described in the present disclosure can be freely combined. For example, the template matching cost can be used to determine whether the dual MPM method is enabled or not. If the dual MPM method is enabled, the selected intra prediction mode by the signaled MPM index is blended with an intra prediction mode before that mode in the MPM list. The blending weights are calculated based on the template matching cost.

In some embodiments, a non-transitory computer-readable storage medium storing a bitstream is also provided. The bitstream can be encoded and decoded according to the disclosed MPM list. In some other embodiments, a method for storing a bitstream is provided. The method for storing the bitstream includes steps of receiving a video sequence including one or more pictures, generating a bitstream including coded information associated with the video sequence, and storing the bitstream in a non-transitory computer-readable medium. For example, the video sequence can be encoded using the video encoding method 1300 in FIG. 13.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A video decoding method, comprising:
selecting a first intra prediction mode and a second intra prediction mode from a most probable mode (MPM) list;
determining a first predictor based on the first intra prediction mode;
determining a second predictor based on the second intra prediction mode;
blending the first predictor and the second predictor to obtain a blended predictor for intra prediction; and
decoding one or more pictures using the blended predictor.

2. The video decoding method according to clause 1, wherein selecting the first intra prediction mode and the second intra prediction mode comprises:
selecting the first intra prediction mode based on a first MPM index signaled in a bitstream; and
selecting the second intra prediction mode based on a second MPM index signaled in the bitstream.

3. The video decoding method according to clause 1 or 2, wherein selecting the first intra prediction mode and the second intra prediction mode comprises:
selecting the first intra prediction mode based on a first MPM index signaled in a bitstream;
determining a second MPM index based on the first MPM index; and
selecting the second intra prediction mode based on the second MPM index.

4. The video decoding method according to any of clauses 1-3, wherein the first intra prediction mode and the second intra prediction mode are adjacent modes in the MPM list.

5. The video decoding method according to any of clauses 1-4, further comprising:
determining whether to blend the first predictor and the second predictor based on a flag signaled in a bitstream.

6. The video decoding method according to any of clauses 1-5, wherein blending the first predictor and the second predictor comprises:
determining a weighted combination of the first predictor and the second predictor.

7. The video decoding method according to clause 6, wherein a first weight for the first predictor and a second weight for the second predictor are determined based on a template matching cost.

8. A video encoding method, comprising:
constructing a most probable mode (MPM) list comprising a first intra prediction mode and a second intra prediction mode;
determining a first predictor based on the first intra prediction mode;
determining a second predictor based on the second intra prediction mode;
blending the first predictor and the second predictor to obtain a blended predictor for intra prediction; and
encoding one or more pictures using the blended predictor.

9. The video encoding method according to clause 8, further comprising:
encoding, in a bitstream associated with the one or more pictures, a first MPM index for selecting the first intra prediction mode; and encoding, in the bitstream, a second MPM index for selecting the second intra prediction mode.

10. The video encoding method according to clause 8 or 9, further comprising:
encoding, in a bitstream associated with the one or more pictures, a first MPM index for selecting the first intra prediction mode, wherein the first MPM index is also used for determining a second MPM index for selecting the second intra prediction mode.

11. The video encoding method according to any of clauses 8-10, wherein the first intra prediction mode and the second intra prediction mode are adjacent modes in the MPM list.

12. The video encoding method according to any of clauses 8-11, further comprising: encoding, in a bitstream associated with the one or more pictures, a flag for determining whether to blend the first predictor and the second predictor.

13. The video encoding method according to any of clauses 8-12, wherein blending the first predictor and the second predictor comprises:
determining a weighted combination of the first predictor and the second predictor.

14. The video encoding method according to clause 13, wherein a first weight for the first predictor and a second weight for the second predictor are determined based on a template matching cost.

15. A method for storing a bitstream, comprising:
receiving a video sequence including one or more pictures;
generating a bitstream comprising coded information associated with the video sequence, the generating of the bitstream comprises:
   constructing a most probable mode (MPM) list comprising a first intra prediction mode and a second intra prediction mode;
   determining a first predictor based on the first intra prediction mode;
   determining a second predictor based on the second intra prediction mode; and
   blending the first predictor and the second predictor to obtain a blended predictor for intra prediction; and
storing the bitstream in a non-transitory computer-readable medium.

16. The method of clause 15, wherein the coded information comprises:
a first MPM index for selecting the first intra prediction mode; and
a second MPM index for selecting the second intra prediction mode.

17. The method of clause 15 or 16, wherein the coded information comprises:
a first MPM index for selecting the first intra prediction mode, wherein the first MPM index is also used for determining a second MPM index for selecting the second intra prediction mode.

18. The method of any of clauses 15-17, wherein the first intra prediction mode and the second intra prediction mode are adjacent modes in the MPM list.

19. The method of any of clauses 15-18, wherein the coded information comprises: a flag for determining whether to blend the first predictor and the second predictor.

20. The method of any of clauses 15-19, wherein blending the first predictor and the second predictor comprises:
determining a weighted combination of the first predictor and the second predictor.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video decoding method, comprising:
selecting a first intra prediction mode and a second intra prediction mode from a most probable mode (MPM) list;
determining a first predictor based on the first intra prediction mode;
determining a second predictor based on the second intra prediction mode;
blending the first predictor and the second predictor to obtain a blended predictor for intra prediction; and
decoding one or more pictures using the blended predictor.

2. The video decoding method according to claim 1, wherein selecting the first intra prediction mode and the second intra prediction mode comprises:
selecting the first intra prediction mode based on a first MPM index signaled in a bitstream; and
selecting the second intra prediction mode based on a second MPM index signaled in the bitstream.

3. The video decoding method according to claim 1, wherein selecting the first intra prediction mode and the second intra prediction mode comprises:
selecting the first intra prediction mode based on a first MPM index signaled in a bitstream;
determining a second MPM index based on the first MPM index; and
selecting the second intra prediction mode based on the second MPM index.

4. The video decoding method according to claim 1, wherein the first intra prediction mode and the second intra prediction mode are adjacent modes in the MPM list.

5. The video decoding method according to claim 1, further comprising:
determining whether to blend the first predictor and the second predictor based on a flag signaled in a bitstream.

6. The video decoding method according to claim 1, wherein blending the first predictor and the second predictor comprises:
determining a weighted combination of the first predictor and the second predictor.

7. The video decoding method according to claim 6, wherein a first weight for the first predictor and a second weight for the second predictor are determined based on a template matching cost.

8. A video encoding method, comprising:
constructing a most probable mode (MPM) list comprising a first intra prediction mode and a second intra prediction mode;
determining a first predictor based on the first intra prediction mode;
determining a second predictor based on the second intra prediction mode;
blending the first predictor and the second predictor to obtain a blended predictor for intra prediction; and
encoding one or more pictures using the blended predictor.

9. The video encoding method according to claim 8, further comprising:
encoding, in a bitstream associated with the one or more pictures, a first MPM index for selecting the first intra prediction mode; and
encoding, in the bitstream, a second MPM index for selecting the second intra prediction mode.

10. The video encoding method according to claim 8, further comprising:
encoding, in a bitstream associated with the one or more pictures, a first MPM index for selecting the first intra prediction mode, wherein the first MPM index is also used for determining a second MPM index for selecting the second intra prediction mode.

11. The video encoding method according to claim 8, wherein the first intra prediction mode and the second intra prediction mode are adjacent modes in the MPM list.

12. The video encoding method according to claim 8, further comprising:
encoding, in a bitstream associated with the one or more pictures, a flag for determining whether to blend the first predictor and the second predictor.

13. The video encoding method according to claim 8, wherein blending the first predictor and the second predictor comprises:
determining a weighted combination of the first predictor and the second predictor.

14. The video encoding method according to claim 13, wherein a first weight for the first predictor and a second weight for the second predictor are determined based on a template matching cost.

15. A method for storing a bitstream, comprising:
receiving a video sequence including one or more pictures;
generating a bitstream comprising coded information associated with the video sequence, the generating of the bitstream comprises:
constructing a most probable mode (MPM) list comprising a first intra prediction mode and a second intra prediction mode;
determining a first predictor based on the first intra prediction mode;
determining a second predictor based on the second intra prediction mode; and
blending the first predictor and the second predictor to obtain a blended predictor for intra prediction; and
storing the bitstream in a non-transitory computer-readable medium.

16. The method of claim 15, wherein the coded information comprises:
a first MPM index for selecting the first intra prediction mode; and
a second MPM index for selecting the second intra prediction mode.

17. The method of claim 15, wherein the coded information comprises:
a first MPM index for selecting the first intra prediction mode, wherein the first MPM index is also used for determining a second MPM index for selecting the second intra prediction mode.

18. The method of claim 15, wherein the first intra prediction mode and the second intra prediction mode are adjacent modes in the MPM list.

19. The method of claim 15, wherein the coded information comprises:
a flag for determining whether to blend the first predictor and the second predictor.

20. The method of claim 15, wherein blending the first predictor and the second predictor comprises:
determining a weighted combination of the first predictor and the second predictor.
